(19) United States
(12) Patent Application Publication
(10) Pub. No.: US 2008/0137172 A1
(43) Pub. Date: Jun. 12, 2008

(54) ARRAY OF GRADUATED PRE-TILTED MEMS MIRRORS

(75) Inventors: Bryan P. Staker, Pleasanton, CA (US); Andres Fernandez, San Francisco, CA (US); Windsor E. Owens, San Francisco, CA (US); Alexander P. Kindwall, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Glimmerglass Networks, Inc., Hayward, CA (US)

(21) Appl. No.: 11/567,723

(22) Filed: Dec. 6, 2006

(51) Int. Cl. G02B 26/00

(52) U.S. Cl. 359/291

(57) ABSTRACT

An array of MEMS devices is formed on a planar substrate having in each of a plurality of annular regions or sectors a plurality of MEMS mirrors of substantially identical structure, wherein the MEMS mirrors in each region have an identical pre-tilt. The pre-tilt is achieved by embedding each dual-axis tiltable mirror within a pre-tilted microplatform or gimbal. In a specific embodiment, one microplatform of a preselected pre-tilt is provided for each micromirror and an underlying electrode is provided having a shape conforming with the pre-tilt. In a specific embodiment, the annular regions are contiguous elliptical or ovoidal regions. By pre-tilt, it is meant that the rest state or nonactuated state of the micro-mirror is such that a reflected beam from a fixed source is directed to the center of a target array.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

This invention relates to optical systems employing an array of micro-electromechanical system (MEMS) mirrors, and particular arrays of MEMS mirrors which are electrically actuated to cause tilting.

MEMS mirrors are used in optical systems, for example in compact, multi-channel free-space optical cross-connect switches whereby switching is accomplished by tilting pairs of dual-axis MEMS mirrors. The performance parameters of the structures are subject to the tilt angle requirements of the optical system. A prior art 64 port cross-connect switch required the application of about 250VDC across each MEMS mirror to achieve a mere 3.6 degree angle displacement on two axes. If a single mirror design is used in order to achieve the required tilt angle displacement over all possible angles, the mirror structure must be over-designed to accommodate all possible loci. As a consequence, the design will be less than optimum for other considerations such as driver voltage requirements, resonance and response limitations affecting switching speed, mirror flatness, optical loss and the number of switchable ports achievable. What is needed is a MEMS mirror useful in a MEMS array structure in which the total amount of active displacement is minimized.

MEMS optical cross-connect switches have been fabricated using microelectronic hybrid techniques wherein an array of MEMS mirrors are fabricated uniformly and simultaneously in or on a flat substrate.

It is known in the prior art to provide off axis collimation of input and output beams to minimize the need to actuate the MEMS mirrors with extreme tilt. An example was manufactured by Integrated Micromachines, Inc., formerly of Monrovia, Calif., which ceased operations in 2003.

The prior art also teaches the concept of converging illumination, wherein source beams converge upon an array. As will be made clear hereinafter, converging illumination is not the same as the present invention.

Referring to FIG. 1, in the prior art MEMS switch 10 with light beams 12 (up to for example 64) from an input array 14 impinge at first fixed locations on a first prior art MEMS array of mirrors 16 and are reflected, when at rest, to a corresponding array mirrors at fixed locations of a second MEMS array 18. The beams are then directed to an output array 20. To address all of the MEMS mirrors of MEMS array 18, the mirrors of array 16 must be able to be tilted through a range of angles from θ₁ at one end of the array 16 to θ₂ at the other end of the array 16, while at the center of the array 16, the center mirror need only be tilted to a maximum of one-half the maximum tilt amplitude. There is a need to reduce the required range of tilt amplitudes and thereby optimize various dimensions of voltage, switch speed and port count.

The following patents show prior art MEMS array structures: U.S. Pat. No. 6,825,967 issued to Chong et al. on Nov. 30, 2004 and assigned to Calient Networks, Inc. of San Jose, Calif., shows symmetrically shaped electrodes.

U.S. Pat. No. 6,487,001 issued to Greywall on Nov. 26, 2002 and assigned to Agere Systems Inc. and Lucent Technologies Inc. of Allentown, Pa. and Murray Hill, N.J., respectively, shows symmetrically shaped electrodes.

PCT Published Patent Application WO 2004/084300 of Silex Microsystems AB of Kista, Sweden, shows various kinds of electrical connections through substrates.

### SUMMARY OF THE INVENTION

According to the invention, an array of MEMS devices is formed on a planar substrate having in each of a plurality of annular regions or sectors a plurality of MEMS mirrors of substantially identical structure, wherein the MEMS mirrors in each annular region have an identical pre-tilt. In a specific embodiment, the pre-tilt is achieved by embedding each dual-axis tiltable mirror within a pre-tilted microplatform or gimbal. One microplatform of a preselected pre-tilt is provided for each micromirror, and an underlying electrode is provided having a shape that accommodates the pre-tilt. In a specific embodiment, the annular regions are contiguous elliptical or oval regions. By pre-tilt, it is meant that the rest state or nonactuated or voltage-off state of the micro-mirror is tilted relative to the plane of the supporting structure or substrate such that a reflected beam from a fixed source to any micromirror at rest is directed substantially to the center of a target array of micromirrors. By pretilting the micromirrors, the angular displacement requirement relative to the rest position of the micromirror is reduced and as a consequence, either the mirror can be made stiffer and thus faster or the voltage requirement can be reduced. Alternatively, if the relative angle remains the same, the number of addressable points can be increased for the same voltage and switch speed requirement.

The invention will be better understood by reference to the following detailed description in connection with the accompanying drawings.

### BRIEF DESCRIPTION OF THE DRAWINGS

FIG. 1 is a schematic diagram of a prior art configuration for a MEMS switch.

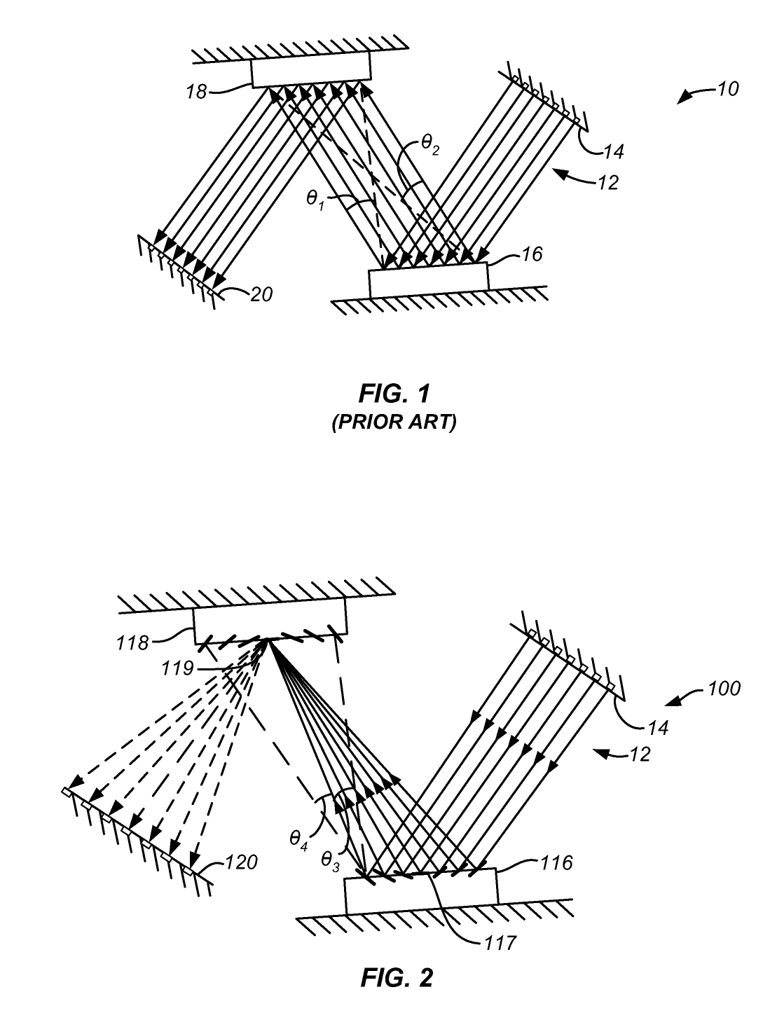

FIG. 2 is a schematic diagram of a configuration for a MEMS switch according to the invention.

FIG. 3 is a side cross-section in schematic form of a MEMS array according to one embodiment of the invention.

FIG. 4 is a top view in schematic form of a MEMS array according to one embodiment of the invention.

FIG. 5 is a cross-sectional view in schematic form of a first embodiment of single MEMS cell illustrating pre-tilt with terraced and tilted electrodes.

FIG. 6 is a side cross-sectional view in schematic form of a second embodiment of the invention illustrating pre-tilt with tilted electrodes.

FIG. 7 is a top view of a single MEMS mirror assembly for illustrating components of the device including a gimbal in accordance with the first embodiment.

FIG. 8 is a side cross sectional view in schematic form of a third embodiment of a single MEMS cell illustrating pre-tilt and a corresponding conforming electrode structure with an over-deflection limiter.

### DETAILED DESCRIPTION OF THE INVENTION

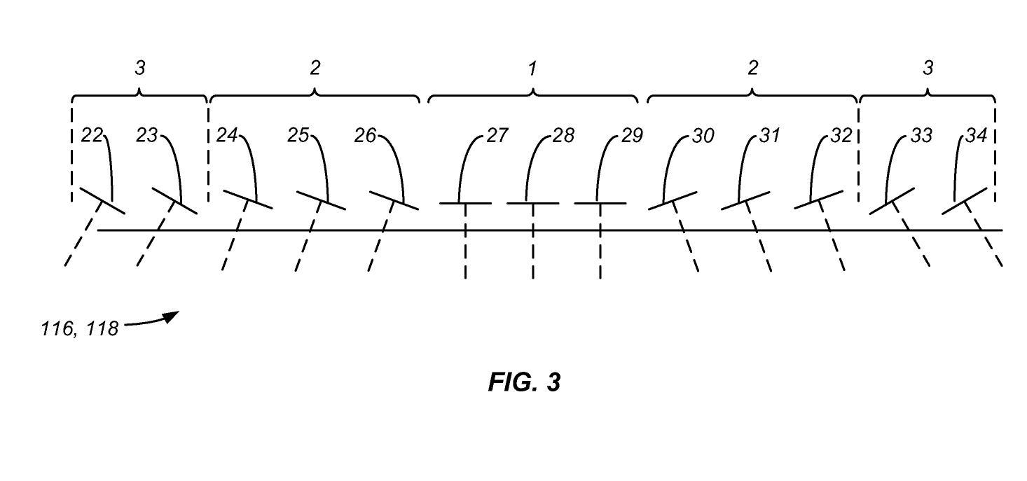

Referring to FIG. 2, a MEMS switch 100 steer light beams 12 from an input array 14 to impinge at first fixed locations on a first MEMS array of mirrors 116 having pre-tilt according to the invention and are reflected, when at rest, to a corresponding central point 119 of an array of mirrors at fixed locations of a second MEMS array 118. The beams are then directed to various locations of an output array 120 in accordance with angle of incidence. To address all of the MEMS mirrors of MEMS array 118, the mirrors of array 116 at rest must be able to be tilted through a range of angles from θ₃ at one extreme of each mirror tilt at one end of the array 116 to θ₄ at the other extreme of the same end of the array 116. A similar mirror tilt displacement range is required at each mirror, which is an angle that approximately corresponds to the same displacement required by the center MEMS mirror 117 at the center of the MEMS array 116, so that the center mirror as well as all other MEMS mirrors in the MEMS array 116 need only be tilted to a maximum of one-half the maximum tilt amplitude of a MEMS array of similar size and form factor of the prior art. This structure is also incorporated in the second MEMS array 118 with similar results and advantages. The reason this result can be achieved lies in the construction of the individual mirrors of the MEMS arrays 116 and 118.

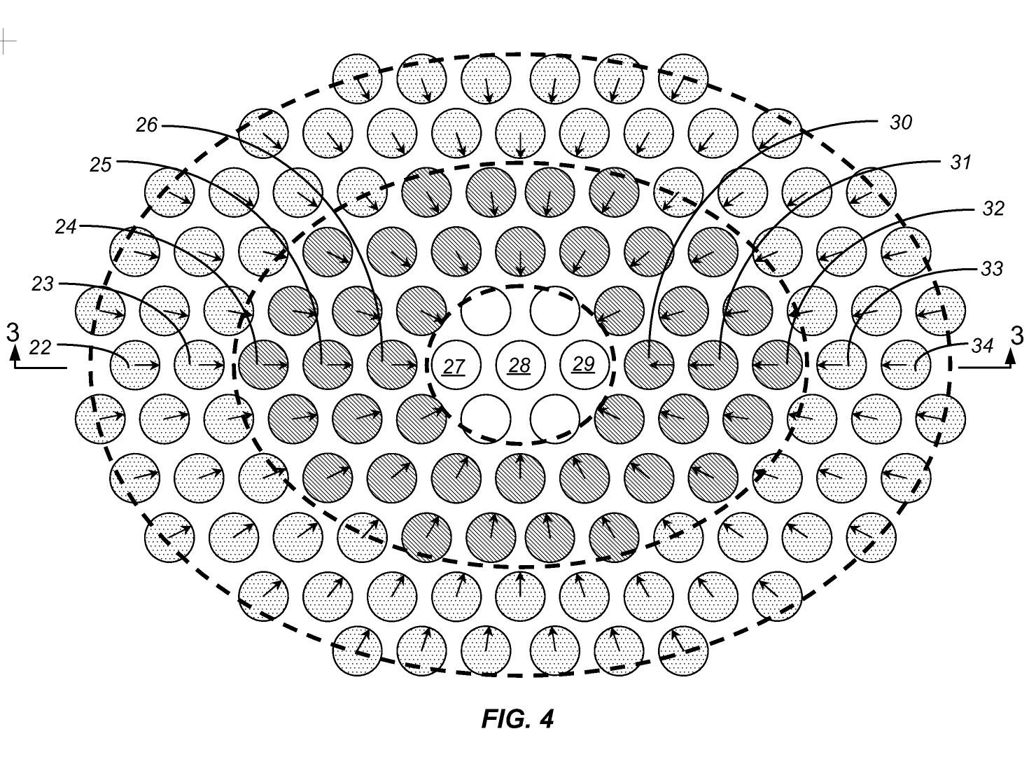

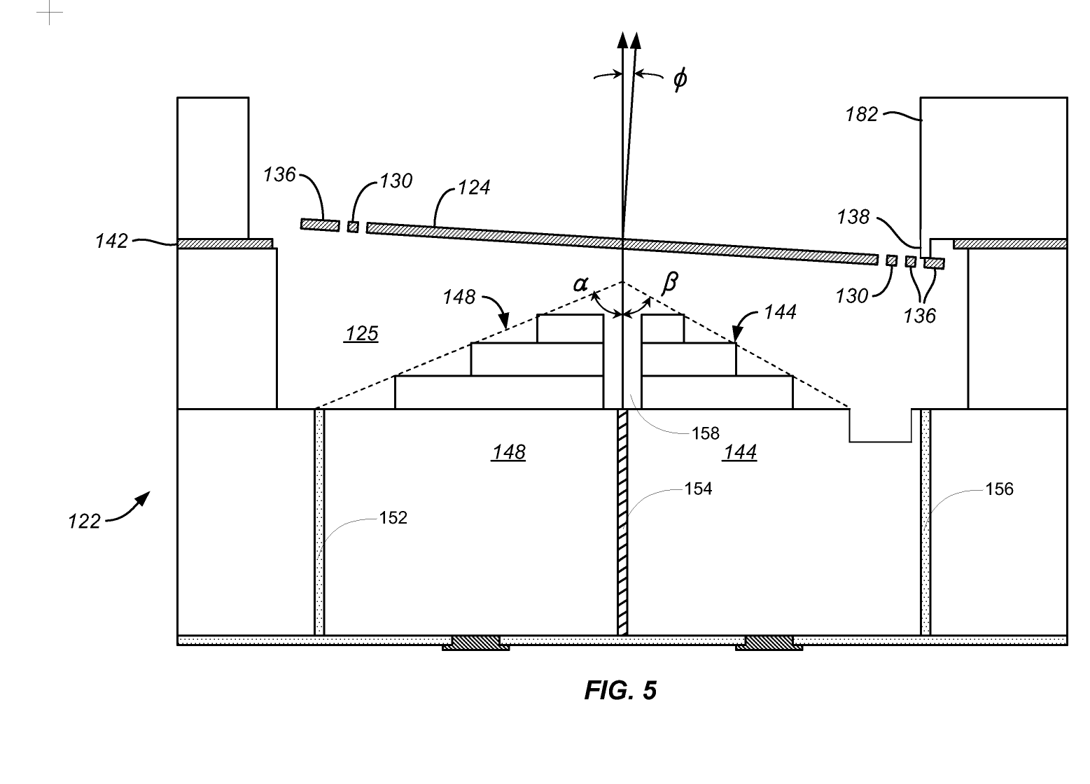

Referring to FIGS. 3 and 4 together, the design of the mirrors of the MEMS arrays 116 and 118 is illustrated schematically. The individual mirrors 22-34 are divided into annular zones 1, 2 and 3, each of which is characterized by a pre-tilt angle for each mirror within the same zone. Zone 1, at the center of the array, contains a number of mirrors around a center mirror 28 which have no pre-tilt. By pre-tilt, it is understood that, in the absence of an applied motive force or the rest position, the plane of the mirrors is at an angle to the plane of its mounting substrate or plane of the array 116. In FIG. 4, vectors out of the center of each mirror indicate the direction of pre-tilt. In FIG. 3, a center axis through each of the mirrors indicates a range of pre-tilt angles, increasing from zero in the central zone 1 to a maximum at the rim zone 3. Of course, fewer or greater number of annular zones are contemplated to be within the scope of the invention. Moreover, as illustrated in FIG. 4, the annular zones may be oval to accommodate optical offsets among elements.

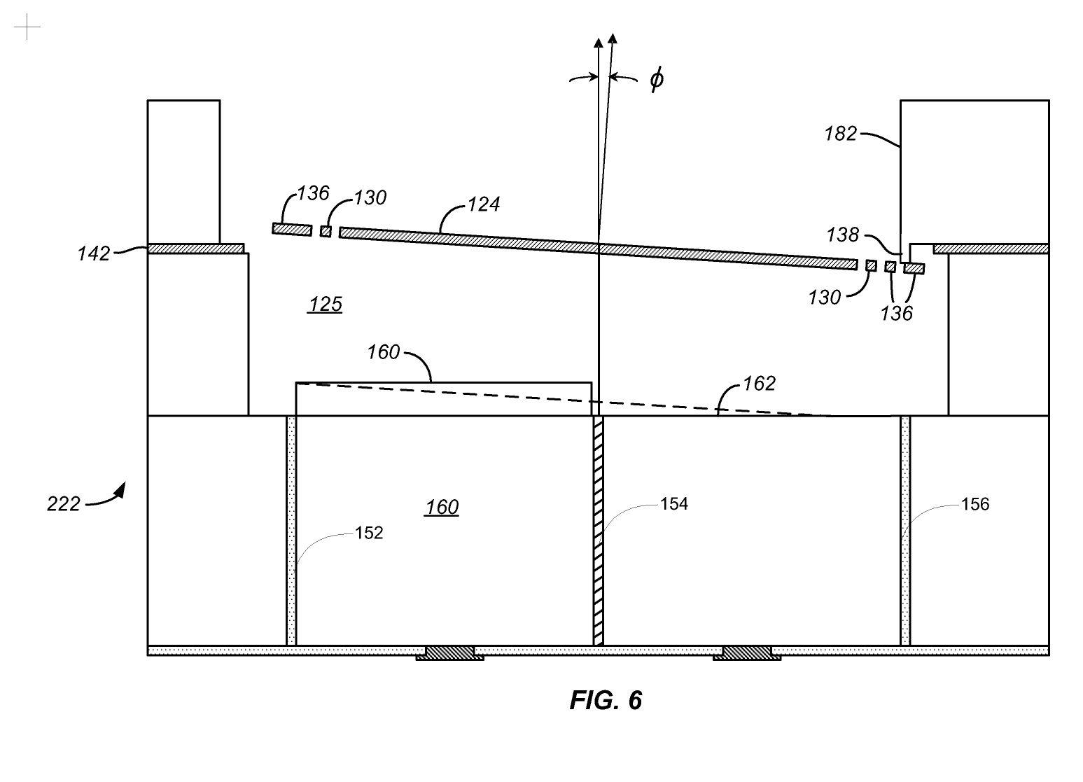

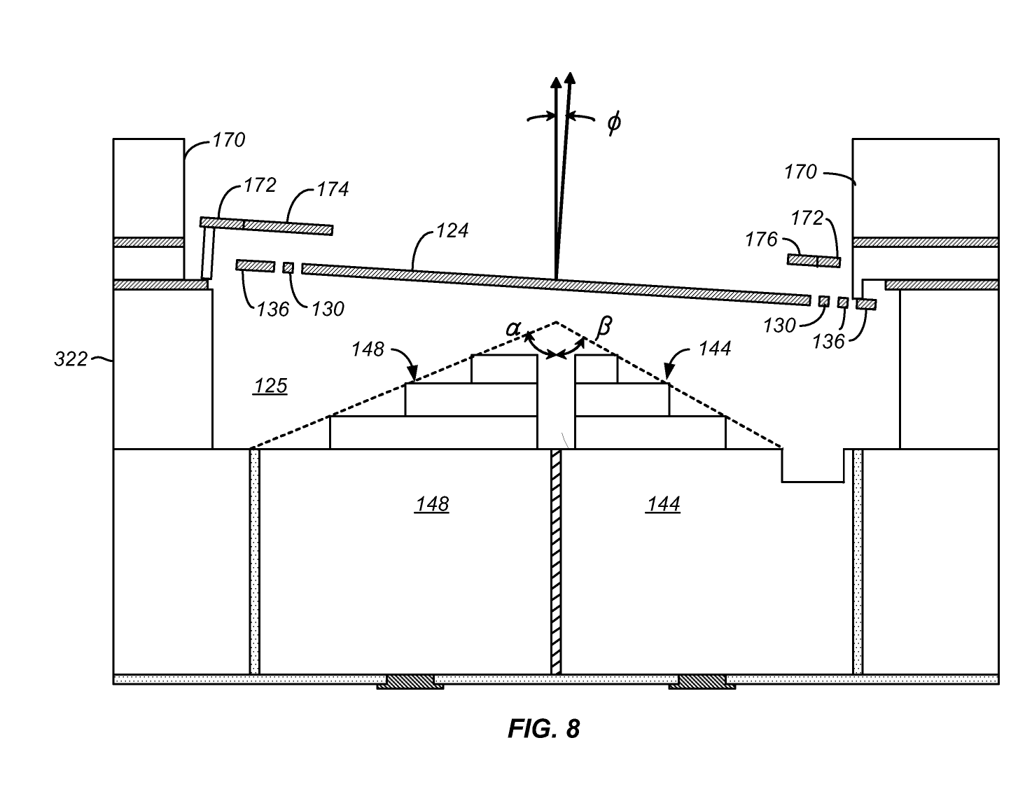

An issue is the manufacturability of MEMS devices with pre-tilted mirrors. MEMS devices are constructed using semiconductor and hybrid circuit fabrication techniques wherein elements are formed by etching and bonding in layers. This form of fabrication does not readily lend itself to asymmetric strata structures, that is structures that have depth dimensions that are dissimilar when viewed in cross-section. An example of a device according to the invention which has an asymmetric strata structure is shown in FIG. 5 and FIG. 7. A single MEMS mirror cell 122 includes a moveable mirror element 124 connected via first and second hinges 126, 128 to an inner gimbal 130. The inner gimbal 130 is in turn connected via second and third hinges 132, 134 to a second or outer gimbal or pre-tilt platform 136. This outer gimbal or pre-tilt platform 136 is connected to the base substrate 142 via fourth and fifth hinges 138, 140, which, according to the invention, establishes the at-rest tilt angle of the micromirror 124. The platform 136 is held at its rest position by a pusher tab 138 (FIG. 5), a point protruding from pusher element 182, which may be a collar around the mirror cavity 125. The point is disposed on one side of the mirror 124 to engage the platform 136, so that the entire platform 136 and mirror structure is pre-tilted. On the opposite side of the mirror 124, the gimbal 130 and platform 136 are raised above the plane of the base substrate 142. Other embodiments for a pre-tilt mechanism include a wedge at one edge, a latch, a cone, a self-assembled pop-up or other mechanical element engaging the platform 136 to hold it at a fixed angle to the plane of the base substrate 142 so that it can be activated by the electrodes 144, 146 and 148.

A further notable aspect of the invention is the structure of electrodes 144, 146, 148, 150 disposed in the mirror cavity 125. The electrodes are tilted relative to the floor of the mirror cavity 125 so that they are nominally equidistant to corresponding regions of the mirror 124 at rest. Note that the angle α is greater than the angle β along the cross section through electrodes 144 and 148. (FIG. 5). The electrodes are typically built up in layers in a section of a cone separated by electrically insulating gaps 152, 154, 156 and having a central hole 158 (or extension of insulator 154). The electrodes are closest to the mirror 124 at its center so that the difference in the force-distance product of the electrodes to the mirror 124 along the radius of the mirror is equalized.

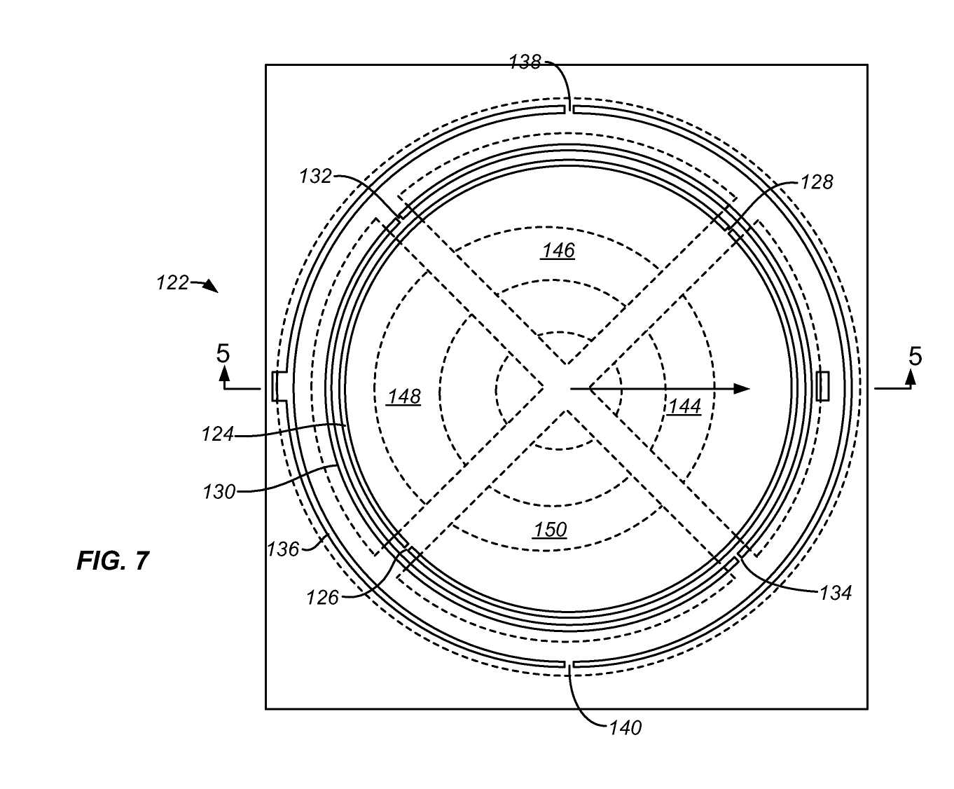

An alternative embodiment without this feature is shown in the MEMS cell 222 of FIG. 6. Therein the electrodes 160, 162 are tilted to match the rest tilt angle of the mirror 124 and are equidistant from the mirror at all radii at rest. In this illustration, there is a discretization of the tilt angle in just two stages. The advantage of tilted electrodes is the advantage of pre-tilted mirror structures and higher mirror density previously described without the complexity of manufacturing of many and varied terraced electrodes. However, structures with pre-tilted and terraced electrodes as in FIG. 5 have the further advantages of even greater possible mirror tilt, which can be translated into even higher mirror count, lower voltage or faster mirrors, in accordance with design requirements.

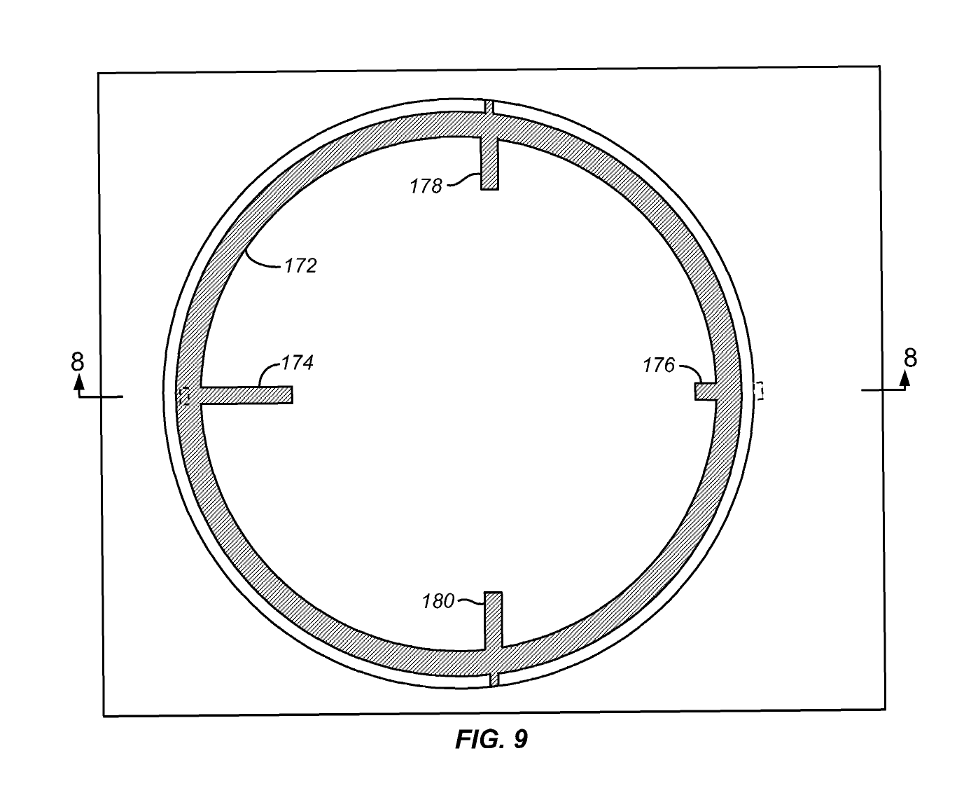

In FIG. 8, a third embodiment of the MEMS cell 322 is shown in cross-section. In comparison with the embodiment of FIG. 5, this embodiment includes a feature for overdeflection prevention in which a frame 170 is disposed adjacent the pre-tilt platform 136 in a further layer and which has a third gimbal 172 that is provided above the mirror 124. Tabs 174 and 176, as well as tabs 178 and 180, for example, are spaced around the gimbal 172, according to design choice, at points where the mirror 124 can be maximally tilted, as shown in FIG. 9. The tabs can also be made integral with the mirror 124, in which instance the gimbal 172 would be routed around the tabs. The shape of the tabs 174, 176, 178 and 180 are typically a matter of design choice.

The invention has been explained with respect to specific embodiments. Other embodiments will be evident to those of ordinary skill in the art. For example, a variety of actuation techniques could be employed other than those herein described without departing from the spirit and scope of the invention. Therefore it is not intended that the invention be limited, except as indicated by the appended claims.

1. A MEMS array for an optical cross connect switch comprising:
a planar substrate having a plurality of annular sectors; and
a plurality of MEMS mirrors of substantially identical structure, wherein the MEMS mirrors in each said annular sector have an identical pre-tilt, said pre-tilt being a rest, nonactuated state of a MEMS mirror at an angle to the plane of said substrate.

2. A MEMS array according to claim 14 further including a pre-tilted platform upon which each said MEMS mirror is mounted to form a pre-tilted unit.

3. A MEMS array according to claim 2 further including an electrode structure underlying each MEMS mirror, said electrode structure having a shape conforming to the pre-tilt of its associated MEMS mirror.

4. A MEMS array according to claim 3 wherein said electrode structure is a conical structure underlying each MEMS mirror.

5. A MEMS array according to claim 4 wherein said conical structure is terraced.

6. A MEMS array according to claim 14 further including an electrode structure underlying each MEMS mirror, said electrode structure having a shape conforming to the pre-tilt of its associated annular sector.

7. (canceled)

8. A MEMS array according to claim 2 wherein said platform is a hinged gimbal which is held at an angle to a nominal plane of said planar substrate.

9. A MEMS array according to claim 8 further including a pusher whereby said hinged gimbal is held at a desired pre-tilt.

10. A MEMS array according to claim 8 further including a mechanical displacement limiter for inhibiting overdeflection of said MEMS mirror.

11. A MEMS array according to claim 10 wherein said mechanical displacement limiter is combined with said pusher.

12. A MEMS apparatus comprising:
a planar substrate;
a MEMS element;
a supporting platform mounted to said substrate and carrying said MEMS element, said supporting platform having a pre-tilt relative to said planar substrate, said pre-tilt being a rest, nonactuated state of said MEMS element at an angle to the plane of said substrate; and
a pusher holding said supporting platform at said pre-tilt.

13. A MEMS apparatus according to claim 12 further including a mechanical displacement limiter, wherein said mechanical displacement limiter is combined with said pusher.

14. A MEMS array according to claim 1 wherein each said annular sector is characterized by a different pre-tilt, said pre-tilt increasing with distance from the center of said MEMS array.
